(19) United States
(12) Patent Application Publication
(10) Pub. No.: US 2012/0083938 A1
(43) Pub. Date: Apr. 5, 2012

(54) Consumer Energy Management System

(76) Inventors: Yasuo Takagi, Kanagawa-ken (JP); Takahiro Yamada, Kanagawa-ken (JP); Masahiko Murai, Tokyo (JP); Tomohiko Tanimoto, Tokyo (JP)

(21) Appl. No.: 13/246,393

(22) Filed: Sep. 27, 2011

(30) Foreign Application Priority Data
Sep. 30, 2010 (JP) 2010-223203

(51) Int. Cl. G06F 1/28

(52) U.S. Cl. 700/296; 700/286

(57) ABSTRACT

A consumer energy management system includes a home gateway configured to receive at least CO2 emission intensity level information or power generation by renewable resources information associated with an electric power system, and a display unit configured to display the CO2 emission intensity level information or the power generation by renewable resources information received by the home gateway

### CROSS-REFERENCE TO RELATED APPLICATIONS

This application is based upon and claims the benefit of priority from Japanese Patent Application No. 2010-223203, filed on Sep. 30, 2010, the entire contents of which are incorporated herein by reference.

### TECHNICAL FIELD

The present disclosure relates to a consumer energy management system for controlling the energy consumed by a consumer entity.

### BACKGROUND

There is known a consumer energy management system that can realize energy savings, cost savings and the reduction of CO₂ emissions by displaying and sometimes controlling the energy consumed by a plurality of appliances provided within a consumer entity such as a home or a shop. Consumer energy management systems may include electric appliances provided in the consumer entity and a control device for controlling the electric appliances. The electric appliances often include a plurality of household electric appliances if the consumer entity is a home. Household energy management systems disclosed in the above reference will now be described. While a variety of verification tests have been conducted in household energy management systems, major items are: (1) the user absence control of an air conditioner by which the air conditioner is turned off if no user exists; (2) the user absence/brightness control of an illumination lamp by which the illumination lamp is turned off or made darker if no user exists; and (3) the standby power cutoff by which the standby power otherwise consumed by household electric appliances is cut off. Examples of the indications on the consumed energy include an indication of electric power consumption amount and gas consumption amount, an indication of the results of energy saving contest among a plurality of households, an indication of advice messages pursuant to the ambient temperature and an indication of CO₂ emission.

The verification tests conducted in the past reveal that the energy saving effect attained by the direct automatic control of household electric appliances is not so great in many cases. On the contrary, the direct automatic control of household electric appliances tends to increase cost and is often found not to be desirable. Visualization of energy consumption is effective with respect to cost. In order to motivate a user to actively cooperate in saving energy, there is a need to improve the visibility and understandability of energy consumption while providing fresh information and amusement.

Consumer energy management systems are designed to reduce the consumption of energy such as electricity and gases used in a home, thereby reducing household energy cost to contribute to the economic benefit of the home and eventually reducing CO₂ emission in the world. Despite such efforts to reduce energy consumption in homes, the percentage of energy consumption that can be reduced by automatic control while suppressing discontent of every home is not so high. In view of this, energy saving is sought by increasing the user's sense of self-participation through visualization of energy consumption. Even in this case, however, the energy saving goal is as low as about 10% of the total energy consumption amount as set forth in the reference cited above.

### BRIEF DESCRIPTION OF THE DRAWINGS

FIG. 1 is a diagram showing the configuration of a consumer energy management system according to one embodiment.

FIGS. 2A and 2B are diagrams illustrating examples of information on a CO2 emission intensity level and information on a power generation by renewable resources amount received by a home gateway of the consumer energy management system.

FIG. 3 is a diagram illustrating one example of the information displayed on a display unit of the consumer energy management system.

FIG. 4 is a diagram illustrating another example of the information displayed on the display unit of the consumer energy management system.

FIG. 5 is a diagram illustrating one example of a process for determining operation schedules of household electric appliances in the consumer energy management system.

### DETAILED DESCRIPTION

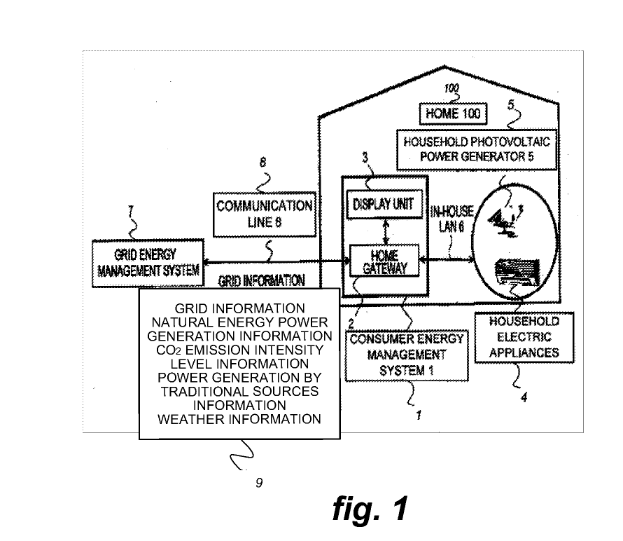

One embodiment of the present disclosure will now be described with reference to FIGS. 1 through 5. FIG. 1 shows the configuration of a consumer energy management system according to one embodiment. The consumer energy management system 1 includes a home gateway 2 for sending and receiving information and a display unit 3 for displaying the information sent and received by the home gateway 2 and the information on the results of calculations performed in the home gateway 2.

Examples of the information 9 sent and received by the home gateway 2 include information on an electric power system (or grid system information), information on a power generation by renewable resources amount (or power generation by renewable resources information), information on a CO2 emission intensity level, information on an amount of power generation such as fossil fuel power generation, nuclear power generation and hydraulic power generation (or power generation by traditional sources information) and weather information. The power generation by renewable resources information includes information on the power generation by renewable resources amount, such as the power generation amount of a photovoltaic power plant or a wind power plant installed in a specified area connected with the electric power system and the power generation amount of a household photovoltaic power generator 5 installed in a home 100, and information on an arbitrary combination of such power generation amounts. The power source power generation information indicates information on the power generation amount of a power source excluding the power generation by renewable resources amount. The CO2 emission intensity level information indicates information on the CO2 emission intensity level equivalent to all kinds of electricity supplied to the home 100 and includes information on the CO2 emission intensity level of fossil fuel power generation, hydraulic power generation, nuclear power generation, photovoltaic power generation, household photovoltaic power generation and wind power generation.

The home gateway 2 receives information from an energy management system 7 of the electric power system through a communication line 8. It is also possible for the home gateway 2 to receive information via a watt-hour meter (a smart meter) or an information modem. The information on the power generation by renewable resources amount and the CO2 emission intensity level received by the home gateway 2 is displayed on the display unit 3. The home gateway 2 may exchange information with energy devices such as the household electric appliances 4 and the household photovoltaic power generator 5 through an in-house LAN 6.

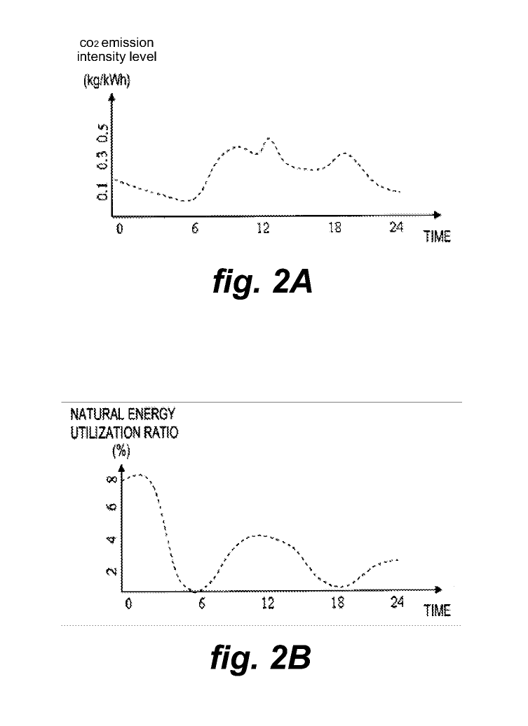

FIGS. 2A and 2B illustrate examples of the information on the CO2 emission intensity level and the information on the power generation by renewable resources amount received by the home gateway 2. FIG. 2A shows one example of the information On the CO2 emission intensity level, and FIG. 2B shows one example of the information on the power generation by renewable resources amount. As shown in FIGS. 2A and 2B, the home gateway 2 receives the information as a one-day trend. This makes it possible to see the time at which the CO2 emission intensity level is kept lowest in a day. The home gateway 2 is also capable of receiving the information as an instant time and a value at the instant time.

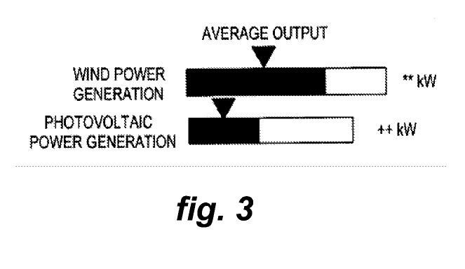

FIG. 3 illustrates one example of the information displayed on the display unit 3. The power generation amount of wind power generation and the power generation amount of photovoltaic power generation are illustrated in the example of FIG. 3. The elongated rectangular frames shown in FIG. 3 indicate power generation capacities during 100% or full power output. In the illustrated example, the power generation capacity of wind power generation is a little greater than the power generation capacity of photovoltaic power generation. The power generation capacity of wind power generation during 100% power output is “** kW”, and the power generation capacity of photovoltaic power generation during 100% power output is “++kW”. The solid-filled portions in the elongated rectangular frames indicate current power generation amounts. The ▾ marks indicate average power output values. In the wind power generation, it is often the case that the average power output is approximately 20% of the maximum capacity. In the photovoltaic power generation, the average power output is about 10% of the maximum capacity.

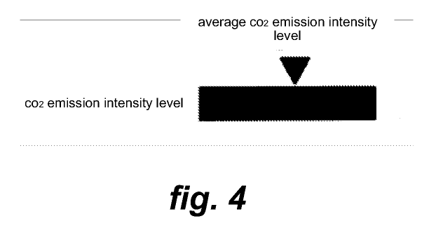

FIG. 4 illustrates another example of the information displayed on the display unit 3. In FIG. 4, there is illustrated the information on the CO2 emission intensity level. The ▾ mark indicates an average CO2 emission intensity level.

The home gateway 2 may calculate the ratio of the power generation by renewable resources amount to the total power generation amount of, e.g., fossil fuel power generation, nuclear power generation and hydraulic power generation (namely, the renewable energy utilization ratio). The result of the calculation may be displayed on the display unit 3 as a predicted value of the renewable energy utilization ratio. The home gateway 2 calculates the renewable energy utilization ratio using equation (1): renewable energy utilization ratio=power generation by renewable resources amount/(power generation by renewable resources amount+fossil fuel power generation amount+nuclear power generation amount+hydraulic power generation amount).

The display unit 3 may display a cumulative renewable energy utilization ratio or a cumulative value of the CO2 emission intensity level past one day or for a suitable time period. In this case, the home gateway 2 calculates a predicted value of the cumulative renewable energy utilization ratio or the cumulative value of the CO2 emission intensity level using equation (2):

$$cumulative renewable energy utilization ratio = {\sum }_{k = Γ - k 0}^{Γ} natural energy utilization ratio ( k ) \times power consumption amount ( k ) / {\sum }_{k = Γ - k 0}^{Γ} power consumption amount ( k )$$

If a photovoltaic power generator, e.g., a household photovoltaic power generator, exists in the consumer entity, the home gateway 2 may calculate the renewable energy utilization ratio and the CO2 emission intensity level by taking the existence of the household photovoltaic power generator into account. The renewable energy utilization ratio and the CO2 emission intensity level thus calculated may be displayed on the display unit 3. In this case, the home gateway 2 calculates a predicted value of the renewable energy utilization ratio using equation (3): renewable energy utilization ratio2 =(purchased power amount x renewable energy ratio of electric power system+photovoltaic power generation amount)/total power consumption amount.

The home gateway 2 calculates a predicted value of the CO2 emission intensity level equivalent to the electricity used by the household electric appliances 4 in the home 100 using equation (4): CO2 emission intensity level=(purchased power amount×CO2 emission intensity level of electric power system+photovoltaic power generation amount×CO2 emission intensity level of photovoltaic power generation)/(purchased power amount+photovoltaic power generation amount), where the purchased power amount is given by sold power amount×(−1) under a power selling situation. In this connection, if a photovoltaic power generator, e.g., a household photovoltaic power generator, exists in the consumer entity, the home gateway 2 calculates the predicted value of the CO2 emission intensity level equivalent to the electricity used in the home 100 by taking the existence of the household photovoltaic power generator into account.

Although not shown in the drawings, it is possible for the display unit 3 to display a message urging a user to use electricity if the power generation by renewable resources amount becomes greater than a reference value or if the CO2 emission intensity level grows smaller than a reference value. More specifically, if the renewable energy is extremely abundant or if the CO2 emission intensity level is very low, the display unit 3 displays a message advising the user of the fact that the electric power is more abundant and the user is allowed to use more electricity than now (namely, a message indicating the user can use more electricity). On the contrary, if the power generation by renewable resources amount is smaller than a normal value or if the CO2 emission intensity level is higher than an average value, the display unit 3 displays a message prompting the user to save electricity. At this time, the home gateway 2 compares an average value for a specified time period of the power generation by renewable resources amount, the renewable energy utilization ratio or the CO2 emission intensity level with a current value of the power generation by renewable resources amount, the renewable energy utilization ratio or the CO2 emission intensity level, and prepares the afore-mentioned messages pursuant to the results of comparison. The display unit 3 displays the messages prepared by the home gateway 2.

Next, a description will be given on how the consumer energy management system 1 predicts the power generation by renewable resources amount or the CO2 emission intensity level in the area inclusive of the consumer entity pursuant to the weather condition included in the weather information and how the consumer energy management system 1 determines the operation schedules of the household electric appliances 4 such that the daily CO2 emission becomes smallest or the renewable energy utilization ratio becomes greatest.

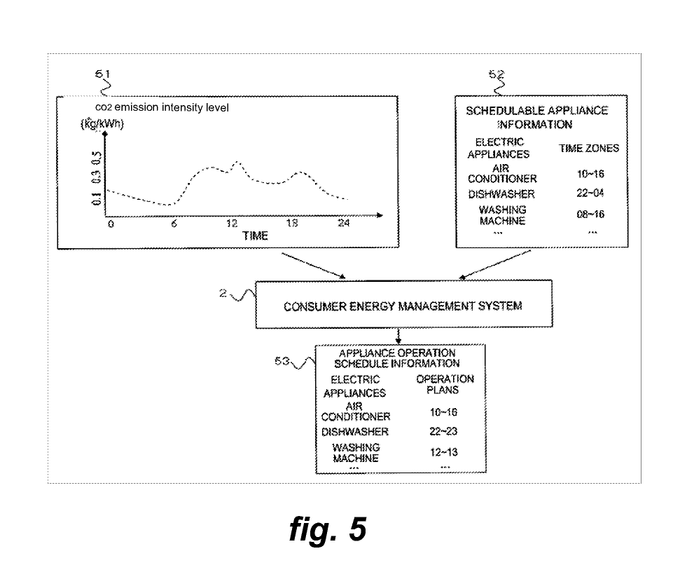

Referring to FIG. 5, one example is illustrated of a process for determining the operation schedules of the household electric appliances 4 in the consumer energy management system 1. The home gateway 2 of the consumer energy management system 1 has a function of automatically selecting the household electric appliances 4 to be used as the subject of the operation schedules, a function of designating the permitted time ranges of the operation schedules, a function of inputting the predicted values of the renewable energy utilization ratio and the CO2 emission intensity level and a function of outputting the operation schedules of the household electric appliances 4.

The home gateway 2 calculates appliance operation schedules 53 based on the CO2 emission intensity level information 51 calculated using the afore-mentioned equation (4) and the schedulable appliance information 52 stored in the home gateway 2. In the home gateway 2, a nonlinear optimization method, a round-robin method or a combination thereof is generally used as the scheduling algorithm for calculating the appliance operation schedules 53. Based on the appliance operation schedules 53 thus calculated, the home gateway 2 may automatically control the household electric appliances 4 through the in-house LAN 6.

In this connection, the CO2 emission intensity level information 51 denotes the information on the daily CO2 emission intensity level equivalent to the electricity used in the home 100. The schedulable appliance information 52 signifies the schedulable household electric appliances and the schedulable time zones corresponding to the schedulable household electric appliances. In the example illustrated in FIG. 5, the schedulable household electric appliances include an air conditioner, a dishwasher and a washing machine, all of which may be selected as the subject of the operation schedules by the home gateway 2. The schedulable time zones are 10:00-16:00 for the air conditioner, 22:00-4:00 for the dishwasher and 8:00-16:00 for the washing machine. The home gateway 2 may designate the permitted time ranges within the schedulable time zones with respect to the schedulable household electric appliances.

The appliance operation schedules 53 indicate the household electric appliances to be operated and the operation plans of the respective household electric appliances. In the example illustrated in FIG. 5, the household electric appliances to be operated include an air conditioner, a dishwasher and a washing machine. The operation plans are made to operate the air conditioner at 10:00-16:00, the dishwasher at 22:00-23:00 and the washing machine at 12:00-13:00.

The display unit 3 displays the appliance operation schedules 53 calculated by the home gateway 2, the advice messages to be read by a user, the reducible amount of CO₂ emission, and so forth.

With the embodiment of the present disclosure, it is possible to display the information on the power generation by renewable resources amount and the CO2 emission intensity level, the renewable energy utilization ratio, the cumulative renewable energy utilization ratio, and the CO2 emission intensity level equivalent to the electricity used in the home. In addition, it is possible to calculate the operation schedules such that the daily CO₂ emission becomes smallest or the renewable energy utilization ratio becomes greatest. By controlling the household electric appliances based on the operation schedules, it becomes possible to significantly reduce the CO₂ emission equivalent to the electricity used in the consumer entity.

This makes it possible to provide a consumer energy management system capable of significantly reducing CO₂ emission equivalent to electricity used in a consumer entity by efficiently utilizing abundant renewable energy whose introduction into an electric power system is delayed due to the large dependency on weather and sun positions and the inherent instability thereof.

With the consumer energy management system of the present disclosure, it is possible to significantly reduce CO₂ emission in a consumer entity by efficiently utilizing renewable energy.

While one embodiment of the present disclosure has been described above, this embodiment is presented by way of example and is not intended to limit the scope of the present disclosure. This embodiment can be modified in many different forms. Various kinds of omission, substitution and modification may be made without departing from the scope and spirit of the present disclosure. This embodiment and the modifications thereof fall within the scope and spirit of the present disclosure and are included in the scope of the present disclosure recited in the claims and the equivalent thereof.

What is claimed is:

1. A consumer energy management system, comprising:
a home gateway configured to receive a CO2 emission intensity level and a power generation level by renewable resources associated with an electric power system; and
a display unit configured to display the CO2 emission intensity level and the power generation level by renewable resources received by the home gateway.

2. The system of claim 1, wherein the power generation level by renewable resources received by the home gateway includes at least a power generation amount of a solar power source or a wind power source installed in the electric power system, or information on a power generation amount of a household solar power source installed in a home.

3. The system of claim 1, wherein the display unit is configured to display a total power generation amount by renewable resources , a renewable energy utilization ratio, and the CO2 emission intensity level.

4. The system of claim 3, wherein the home gateway is configured to calculate the power generation amount by renewable resources or the CO2 emission intensity level by taking into account consumer-managed power generation level by renewable resources, and wherein the display unit is configured to display the power generation amount by renewable resources or the CO2 emission intensity level calculated by taking into account the consumer-managed power generation by renewable resources.

5. The system of claim 3, wherein the home gateway is configured to calculate a cumulative value or an average value of at least one of the power generation amount by renewable resources , the renewable energy utilization ratio and the CO2 emission intensity level for a predetermined time period, and wherein the display unit is configured to display the cumulative value or the average value of at least one of the power generation amount by renewable resources , the renewable energy utilization ratio and the CO2 emission intensity level for the predetermined time period.

6. The system of claim 5, wherein the home gateway is configured to compare the average value of one of the power generation amount by renewable resources , the renewable energy utilization ratio or the CO2 emission intensity level for the predetermined time period with an average value of one of the power generation amount by renewable resources, or the renewable energy utilization ratio or the CO2 emission intensity level at the present time to prepare a message corresponding to the results of the comparison, and wherein the display unit is configured to display the message prepared by the home gateway.

7. The system of claim 1 further comprising a grid energy management system configured to send at least information on a CO2 emission intensity level or information on a power generation level by renewable resources associated with an electric power system to the home gateway.

8. A consumer energy management system, comprising:
a home gateway configured to receive weather information, calculate a local power generation amount by renewable resources or a local CO2 emission intensity level based on the weather information, and calculate operation schedules of household electric appliances based on the local CO2 emission intensity level; and
a display unit configured to display the operation schedules of household electric appliances calculated by the home gateway.

9. The system of claim 8, wherein the home gateway is configured to calculate the operation schedules such that a CO₂ emission for a predetermined time period is minimized or a renewable energy utilization ratio for a predetermined time period is maximized, and wherein the display unit displays the calculated operation schedules.

10. The system of claim 8 wherein the home gateway is configured to receive at least information on a CO2 emission intensity level or information on a power generation level by renewable resources associated with an electric power system; and the display unit is configured to display the information on the CO2 emission intensity level or the information on the power generation by renewable resources information received by the home gateway.

11. The system of claim 8 further comprising a grid energy management system configured to send at least information on a CO2 emission intensity level or information on a power generation level by renewable resources associated with an electric power system to the home gateway.

12. The system of claim 8 wherein the display unit is configured to display a total power generation amount by renewable resources , a renewable energy utilization ratio, and the CO2 emission intensity level.

13. The system of claim 12, wherein the home gateway is configured to calculate the power generation amount by renewable resources or the CO2 emission intensity level by taking into account consumer-managed power generation level by renewable resources, and wherein the display unit is configured to display the power generation by renewable resources or the CO2 emission intensity level calculated by taking into account the consumer-managed power generation by renewable resources.

14. A home energy management method comprising:
receiving through a home gateway information on a CO2 emission intensity level or information on a power generation level by renewable resources associated with an electric power system; and
displaying through a display connected to the home gateway the information on the CO2 emission intensity level or the information on the power generation by renewable resources information received by the home gateway.

15. The method of claim 14 wherein the information on the power generation by renewable resources received by the home gateway includes at least information on a power generation amount of a photovoltaic power plant or a wind power plant installed in a specified area or information on a power generation amount of a household photovoltaic power generator installed in a home.

16. The method of claim 14 further comprising displaying a total power generation amount by renewable resources, a renewable energy utilization ratio, and the CO2 emission intensity level.

17. The method of claim 14 further comprising:
calculating by the home gateway power generation amount by renewable resources or the CO2 emission intensity level by taking into account consumer-managed power generation level by renewable resources; and
displaying through a display the power generation amount by renewable resources or the CO2 emission intensity level calculated by taking into account the consumer-managed power generation by renewable resources.

18. The method of claim 14 further comprising:
receiving weather information by the home gateway,
calculating a local power generation amount by renewable resources or a local CO2 emission intensity level based on the weather information by the home gateway;
calculating operation schedules of household electric appliances based on the local CO2 emission intensity level by the home gateway; and
displaying the operation schedules of household electric appliances calculated by the home gateway by the display.

19. The method of claim 18 wherein the home gateway calculates the operation schedules such that a CO₂ emission for a predetermined time period is minimized or a renewable energy utilization ratio for a predetermined time period is maximized, and wherein the display unit displays the calculated operation schedules.

20. The method of claim 14 further comprising sending at least information on a CO2 emission intensity level or information on a power generation level by renewable resources associated with an electric power system to the home gateway from a grid energy management system.
